(19) United States
(12) Patent Application Publication
(10) Pub. No.: US 2006/0088747 A1
(43) Pub. Date: Apr. 27, 2006

(54) Thin film electrolyte assembly

(76) Inventors: Yoocharn Jeon, Palo Alto, CA (US); Alfred I-Tsung Pan, Sunnyvale, CA (US); Laurie S. Mittelstadt, Belmont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/297,910

(22) Filed: Dec. 9, 2005

Related U.S. Application Data
(63) Continuation-in-part of application No. 10/968,724, filed on Oct. 18, 2004.

(51) Int. Cl. H01M 8/10; H01M 8/02; B05D 5/12; H01M 4/90; H01M 4/92

(52) U.S. Cl. 429/30; 429/34; 429/33; 429/40; 427/115

(57) ABSTRACT

A thin film electrolyte assembly includes a frame and a thin film at least partially contacting the frame. The thin film includes a metal layer having two opposed sides, a large surface area metal layer established on each of the two opposed sides of the metal layer, and an electrolyte membrane established on each of the large surface area metal layers.

### CROSS REFERENCE TO RELATED APPLICATIONS

This application is a continuation-in-part of co-pending U.S. application Ser. No. 10/968,724, filed Oct. 18, 2004, which is hereby incorporated by reference in its entirety.

### BACKGROUND

Fuel cells use an electrochemical energy conversion of fuel (including but not limited to hydrogen, propane, methane, and the like) and oxidant(s) into electricity and heat. It is anticipated that fuel cells may be able to replace primary and secondary batteries as a portable power supply. In fuel cells, the fuel (usually containing a source of hydrogen) is oxidized typically with a source of oxygen to produce (primarily) water, and potentially carbon dioxide. The oxidation reaction at the anode, which liberates electrons, in combination with the reduction reaction at the cathode, which consumes electrons, results in a useful electrical voltage and current through the load.

As such, fuel cells provide a direct current (DC) voltage that may be used to power motors, lights, electrical appliances, etc. A direct methanol fuel cell (DMFC) is one type of fuel cell that may be useful in portable or non-portable applications. A DMFC may have substantially the same catalyst for the anode and the cathode, thus making it desirable to keep the methanol fuel separated from the oxidant. One problem that may, in some instances, be associated with a DMFC is that methanol fuel may cross/diffuse from the anode to the cathode, thus undesirably resulting in fuel consumption without any electrochemical reaction. Further, fuel oxidation at the cathode may consume oxygen that would otherwise react with protons to provide a driving force to the fuel cell reaction. Therefore, methanol crossover may undesirably lower efficiency, generate heat, and substantially deteriorate the performance of the fuel cell.

Many attempts have been made to reduce methanol crossover, including diluting methanol fuel and using membranes with lower methanol permeability. However, diluted methanol fuel may result in excess water being left in the fuel cell after the fuel is consumed. Further, membranes with lower methanol permeability may have, in some instances, poor ionic conductivity.

As such, there is a need for providing a fuel cell that substantially prevents fuel crossover from the anode to the cathode.

### SUMMARY

A thin film electrolyte assembly includes a frame and a thin film at least partially contacting the frame. The thin film includes a metal layer having two opposed sides, a large surface area metal layer established on each of the two opposed sides of the metal layer, and an electrolyte membrane established on each of the large surface area metal layers.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is a flow diagram depicting an embodiment of a method of making a thin film electrolyte assembly;

FIG. 2 is a top view of an embodiment of a thin film electrolyte assembly;

FIG. 2A is a semi-schematic cross-sectional view taken on line 2A-2A of FIG. 2;

FIG. 3 is a top view of another embodiment of a thin film electrolyte assembly;

FIG. 3A is a semi-schematic cross-sectional view taken on line 3A-3A of FIG. 3;

FIG. 4 is a top view of another embodiment of a thin film electrolyte assembly;

FIG. 4A is a semi-schematic cross-sectional view taken on line 4A-4A of FIG. 4; and

FIG. 5 is a schematic view of an embodiment of a fuel cell.

### DETAILED DESCRIPTION

Embodiment(s) of the present disclosure provide an electrolyte assembly for use in fuel cells, such as, for example, a direct methanol fuel cell (DMFC). Without being bound to any theory, it is believed that embodiment(s) of the electrolyte assembly advantageously substantially prevent fuel crossover in the fuel cells. Further, the electrolyte assembly may be a thin film structure. Advantages of a thin film structure include, but are not limited to, a reduction in fuel cell system resistance and a reduction in manufacturing costs.

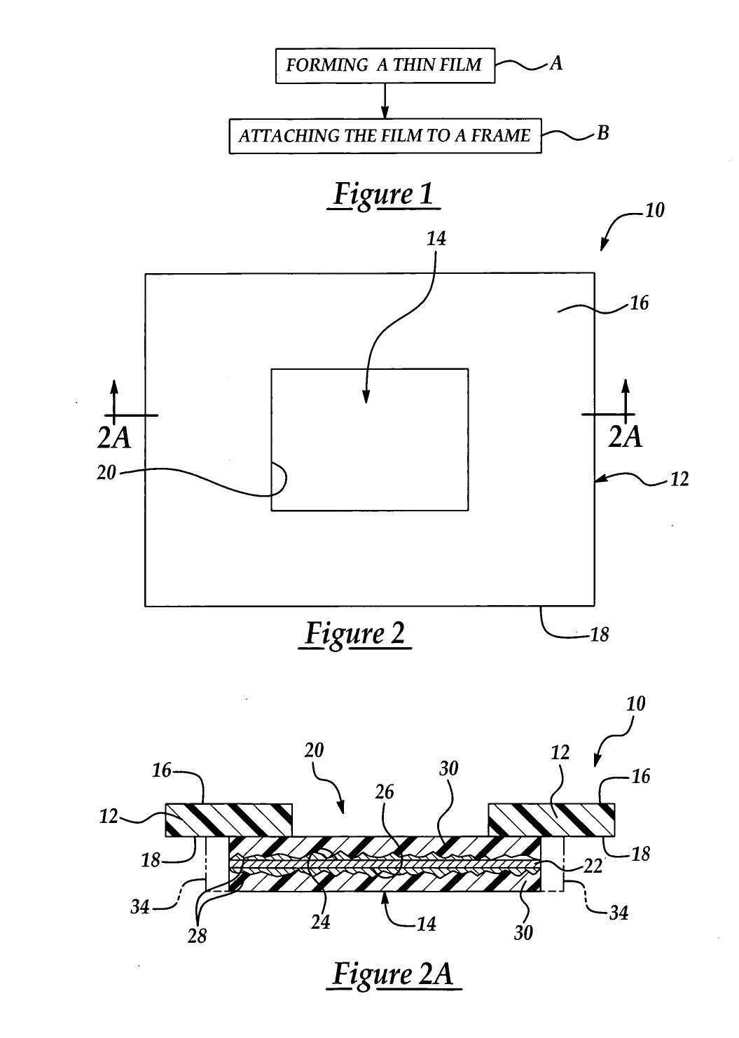

FIG. 1 depicts an embodiment of a method of making the electrolyte assembly. Generally, the method includes forming a thin film, as shown at A; and attaching the thin film to a frame, as shown at B. The method may also include forming one or more apertures in the frame prior to attaching the thin film thereto. It is to be understood that embodiment(s) of the method will be discussed in more detail hereinbelow in reference to the other Figures.

Referring now to FIGS. 2 and 2A, an embodiment of electrolyte assembly 10 is shown. FIG. 2A is a cross-sectional view of the embodiment of the electrolyte assembly 10. The electrolyte assembly 10 includes a frame 12 and a thin film 14 contacting the frame 12.

The frame 12 may be made of any suitable material that includes one or more of the following characteristics: electrically insulating, impermeable to fuel, impermeable to oxygen, insoluble in fuel, insoluble in water, and/or combinations thereof. Examples of suitable materials include, but are not limited to, polyimide membranes, nylon, nickel, silver, and/or combinations thereof. An example of a polyimide membrane is commercially available under the tradename KAPTON from DuPont, located in Circleville, Ohio.

It is to be understood that the frame 12 may have any suitable size, shape, configuration, and/or geometry as desired. Further, the frame 12 may have any suitable thickness. In an embodiment, the thickness of the frame 12 ranges from about 10 microns to about 100 microns. It is to be understood that the frame 12 may be formed as thin as possible, as long as a desirable mechanical strength of the frame 12 is not deleteriously affected.

In an embodiment, the frame 12 has two faces, a first face 16 and a second face 18. As shown in FIG. 2A, the thin film 14 is attached to the second face 18. However, it is to be understood that the thin film 14 may be attached to either the first or the second face 16, 18. It is to be further understood that the thin film 14 may contact (be attached to) all or a portion of the frame 12.

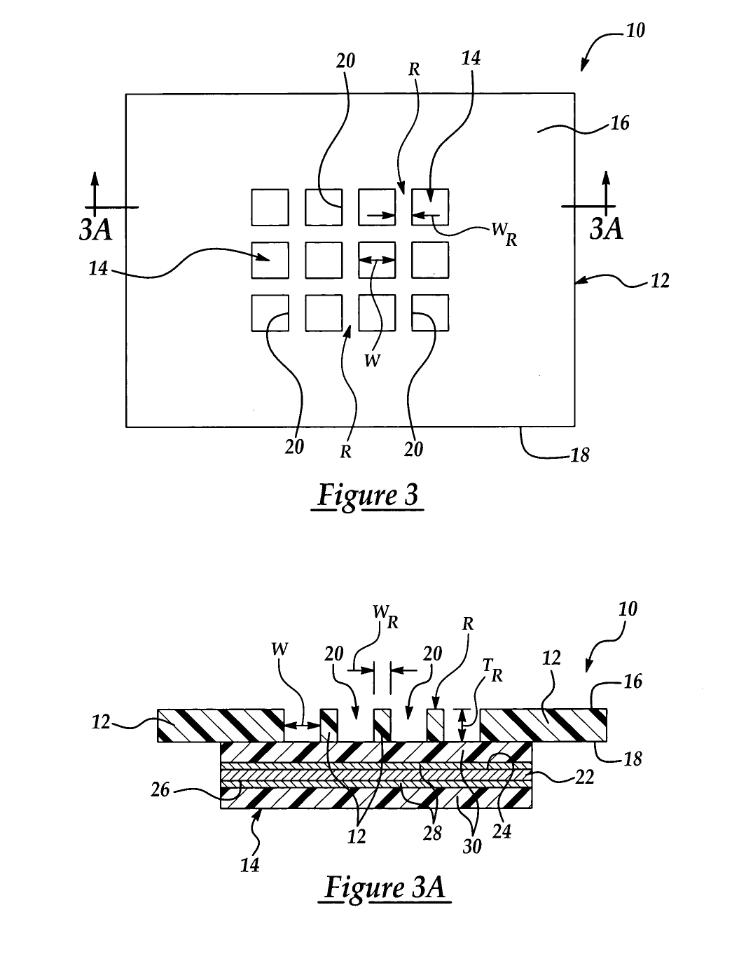

As further shown in FIG. 2A, the frame 12 may also include an aperture 20 (or a plurality of apertures 20 as shown in FIGS. 3 and 3A) extending therethrough. It is to be understood that the aperture 20 may be formed in the frame 12 prior to attaching the thin film 14 thereto. Alternately, a frame 12 having a previously formed aperture 20 may be purchased commercially. Generally, the aperture 20 may be customized so it is capable of supporting a desirable thin film 14. In an embodiment, the aperture(s) 20 are formed via punching, cutting, molding, laser ablation, weaving, and/or the like, and/or combinations thereof.

It is to be understood that the size of the aperture(s) 20 may vary in order to optimize the mechanical properties of the frame 12, while maintaining a desirably high surface area of the opening(s) forming the aperture(s) 20. Smaller aperture(s) 20 (as shown in FIG. 3) may assist in increasing the mechanical properties, e.g. robustness, of the thin film 14, which contacts the frame 12. Further, the aperture(s) 20 are sized so that the frame 12 may adequately support the thin film 14.

In an embodiment, thin film conductors 34 (shown in phantom in FIG. 2A) may be deposited on the frame 12 at opposed sides of the thin film 14. This may provide an effective current path between the two sides to enable monitoring or biasing of the metallurgical status of the thin film 14 by monitoring its electrical status. The thin film conductors 34 may be formed from any chemically inert conductor, non-limitative examples of which include gold, palladium, platinum, ruthenium, iridium, nickel, and/or the like, and/or combinations thereof.

In an embodiment, the aperture(s) 20 may be covered by the thin film 14. It is to be understood that upon attaching the thin film 14 to the frame 12, the thin film 14 generally does not extend into the aperture(s) 20, rather the thin film 14 covers the area of the aperture(s) 20 that corresponds with whichever face 16, 18 of the frame 12 the thin film 14 contacts. FIG. 2A depicts a non-limitative example in which the thin film 14 covers the area of the aperture 20 that corresponds with the second face 18 of the frame 12.

Embodiment(s) of the thin film 14 include a metal layer 22 having two opposed sides 24, 26. It is to be understood that the metal layer 22 is permeable to hydrogen but impermeable to hydrocarbon fuel molecules. As such, the metal layer 22 may advantageously assist in substantially preventing fuel crossover in the fuel cell. Non-limitative examples of suitable materials for the metal layer 22 include niobium, vanadium, tantalum, palladium, iron, and/or alloys thereof (a non-limitative example of which includes palladium silver alloys), and/or combinations thereof. The metal layer 22 may be of any suitable thickness. In an embodiment, the thickness of the metal layer 22 ranges from about 10 nanometers to about 100 microns. In another embodiment, the metal layer 22 has a thickness ranging from about 0.1 microns to about 10 microns.

The thin film 14 may include other layers to substantially protect the metal layer 22 from cracking and/or to substantially enhance the transfer of protons through the film 14. In an embodiment, the thin film 14 includes a large surface area metal layer 28 formed on each of the opposed sides 24, 26 of the metal layer 22. In an embodiment, each of the large surface area metal layers 28 has a surface area ranging from about 2 times to about 1000 times the projected area, the projected area generally not being the actual surface area, but rather the apparent area when viewed in two dimensions. It is to be understood that the large surface area metal layers 28 advantageously increase the surface area of the metal film 22.

In a non-limitative example, the large surface area metal layers 28 may be formed from any of palladium-black, tantalum-black, iron-black, vanadium-black, or combinations thereof. It is to be understood that the surface of any of the above (Pd-black, Ta-black, Fe-black, and/or V-black) may be covered with a thin layer of palladium and/or a palladium alloy. In a further non-limitative example, each of the large surface area metal layers 28 is a palladium-black layer. In yet another non-limitative example, each of the large surface area metal layers 28 is a palladium-black layer having platinum-containing catalyst material established on its surface. Examples of platinum-containing catalyst materials include, but are not limited to platinum catalyst particles and platinum-ruthenium catalyst particles. Such particles may be finely distributed so they at least partially cover the large surface area metal layers 28. Generally, the catalyst material substantially enhances the catalytic activity of the surface. In an embodiment, the platinum-containing catalyst particles may be deposited by electroplating from a solution containing platinum and/or ruthenium.

The large surface area metal layers 28 may be formed by any suitable method. In an embodiment of the method, the layers 28 are formed by electrodeposition, sputtering, evaporation of the metal in the presence of an inert gas, and/or the like, and/or combinations thereof. It is to be understood that each of the formed large surface area metal layers 28 may be a continuous layer or a non-continuous layer. In an embodiment wherein each of the large surface area metal layers 28 is non-continuous, it is to be understood that any additional layers disposed thereon may contact areas of both the large surface area metal layer(s) 28 and the metal layer 22.

The large surface area metal layers 28 may be of any suitable thickness. In an embodiment, the thickness of each of the large surface area metal layers 28 ranges from about 10 nanometers to about 100 microns, and in another embodiment, the thickness ranges from about 0.5 microns to about 2 microns.

The thin film 14 further includes an electrolyte membrane 30 established on each of the large surface area metal layers 28. It is to be understood that each of the electrolyte membranes 30 may be established via any suitable deposition technique. Such deposition techniques include, but are not limited to, casting, lamination, spin coating, screen printing, dip coating, meniscus coating, and spray coating. Spin coating generally forms very thin film thicknesses and small, intricate geometries. In an embodiment, the thin film thicknesses are less than or equal to about 1 μm. Screen printing generally forms thicker film thicknesses and larger geometries. In an alternate embodiment, the thicker film thicknesses are greater than or equal to about 10 microns.

In an embodiment, each of the electrolyte membranes 30 ranges in thickness from about 1 micron to about 50 microns. In an alternate embodiment, each of the electrolyte membranes 30 has a thickness of about 10 microns.

The electrolyte membranes 30 may be made of any suitable material. In an embodiment, the electrolyte membranes 30 are a polymer electrolyte membrane, such as, for example, NAFION, which is commercially available from DuPont, located in Circleville, Ohio.

Other examples of suitable polymers for the electrolyte membranes include, but are not limited to sulfonated derivatives of a polymer that includes a lyotropic liquid crystalline polymer, such as a polybenzazole (PBZ) or polyaramid (PAR or KEVLAR which is commercially available from DuPont) polymers. Non-limitative examples of polybenzazole polymers include polybenzoxazole (PBO), polybenzothiazole (PBT) and polybenzimidazole (PBI) polymers. Examples of polyaramid polymers include, but are not limited to polypara-phenylene terephthalimide (PPTA) polymers.

The electrolyte membranes 30 may also include a sulfonated derivative of a thermoplastic or thermoset aromatic polymer. Non-limitative examples of the aromatic polymers include polysulfones (non-limitative examples of which include polyethersulfone (PES), polyetherethersulfone (PEES), polyarylsulfone, polyarylethersulfone (PAS), polyphenylsulfone (PPSU) and polyphenylenesulfone (PPSO₂) polymers); polyimides (non-limitative examples of which include polyetherimide and fluorinated polyimides); polyphenylene oxides (PPO); polyphenylene sulfoxides (PPSO); polyphenylene sulfides (PPS); polyphenylene sulfide sulfones (PPS/SO₂); polyparaphenylenes (PPP); polyphenylquinoxalines (PPQ); polyarylketones (PK); polyetherketones (non-limitative examples of which include polyetheretherketone (PEEK), polyetherketone-ketone (PEKK), polyetheretherketoneketone (PEEKK) and polyetherketoneetherketone-ketone (PEKEKK)), and mixtures thereof.

It is to be understood that the electrolyte membranes 30 may also include a sulfonated derivative of a non-aromatic polymer, such as a perfluorinated ionomer. Examples of suitable ionomers include, but are not limited to carboxylic, phosphonic, or sulfonic acid substituted perfluorinated vinyl ethers.

Still further, the polymer electrolyte membrane may include a sulfonated derivative of blended polymers, such as a blended polymer of PEKK and PEEK.

The electrolyte membranes 30 may have a composite layer structure including two or more polymer layers. Non-limitative examples of composite layer structures are NAFION or PBI membranes coated with sulfonated polyetheretherketone (sPEEK) or sulphonated polyetheretherketone-ketone (sPEEKK). The polymer layers in a composite layer structure may be blended polymer layers, unblended polymer layers, and/or a combination thereof.

In an embodiment, the overall thickness of the thin film 14, including the metal layer 22, the large surface area metal layers 28, and the electrolyte membranes 30, ranges from about 10 microns to about 100 microns.

In a non-limitative example, the thin film 14 includes a metal layer 22 of palladium, large surface area metal layers 28 of palladium black, and electrolyte membranes 30 of polyimide.

FIG. 2A shows the thin film 14 attached to a portion of the frame 12. It is to be understood that the thin film 14 may contact (be attached to) all or a portion of the frame 12. In an embodiment of the method, the thin film 14 is attached to the frame 12 via the electrolyte membrane 30 of the thin film 14.

One method for attaching the thin film 14 to the frame 12 is heat staking. It is to be understood that heat staking cures one of the electrolyte membranes 30 to one of the faces 16, 18 of the frame 12, thereby creating adequate adhesion between the two. It is to be further understood that heat staking may take place at a temperature ranging from about 20° C. to about 350° C., or at a temperature ranging from about 100° C. to about 170° C.

Another method for attaching the thin film 14 to the frame 12 includes applying an adhesive between the film 14 and the frame 12. Generally, the adhesive selected is insoluble in the fuel, insoluble in water, impermeable to the fuel, and/or impermeable to oxygen. It is to be understood that the adhesive should facilitate adhesion between the frame 12 and the electrolyte membrane 30 or the metal layer 22 of the thin film 14. In an embodiment, the adhesive is an acrylic adhesive or a phenolic adhesive.

Applying pressure to the thin film 14 and frame 12 may advantageously aid in adhering the two surfaces together. Pressure may allow areas of the film 14 and frame 12 to contact each other where they otherwise may not be in contact. Further, pressure may allow adhesive to flow into recessed areas. Generally, the pressure may range from about 10 psi to about 1000 psi. In a non-limitative embodiment, the pressure ranges from about 50 psi to about 500 psi.

FIG. 2 is top view of the embodiment of the electrolyte assembly 10 shown in FIG. 2A. As depicted, the thin film 14 may be seen through the aperture 20 in the frame 12.

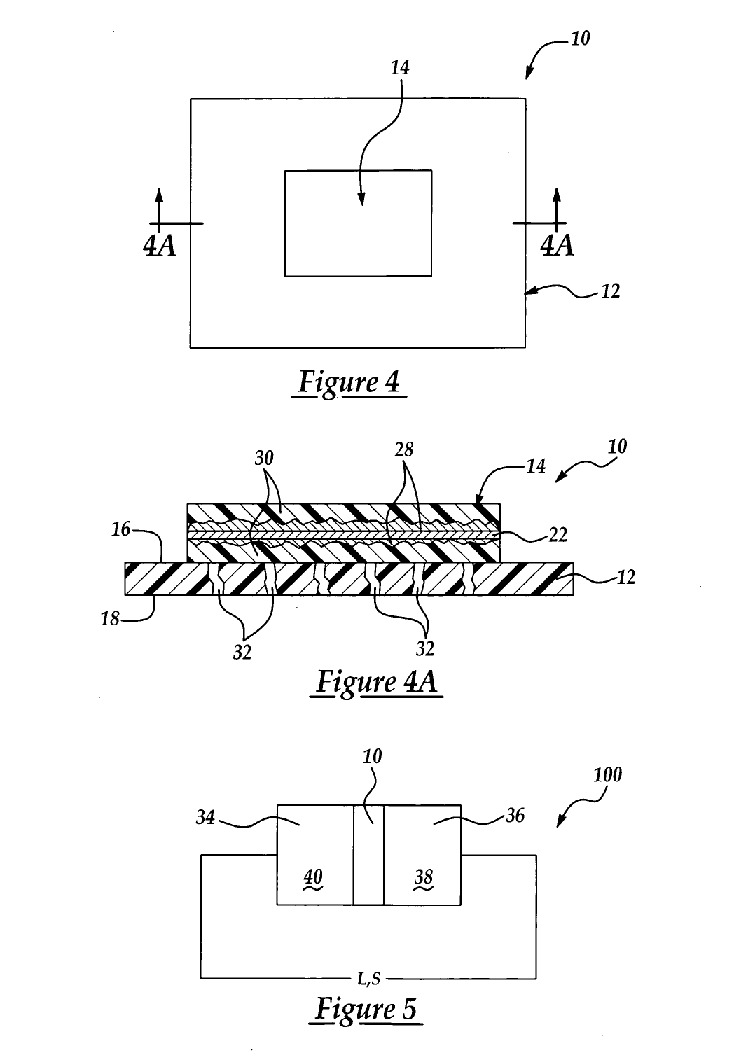

It is to be understood that the materials and methods described herein in reference to FIGS. 2 and 2A may be used to form the embodiments shown in FIGS. 3, 3A, 4 and 4A.

Referring now to FIGS. 3 and 3A together, an embodiment of the electrolyte assembly 10 is depicted both from a cross-sectional view (FIG. 3A) and a top view (FIG. 3). In this embodiment, the frame 12 has a plurality of apertures 20 formed therein and extending therethrough. The area(s) of the frame 12 located between the apertures 20 is/are generally referred to as the rib(s) R of the frame 12.

It is to be understood that the plurality of apertures 20 may be of any suitable size, shape, pattern, configuration, and/or geometry. In this non-limitative embodiment, the width W of each aperture 20 is about three or more times larger than the width W_{R} of the rib R, which is about 1 to about 100 times the thickness T_{R} of the rib R.

As previously discussed, the smaller apertures 20 may advantageously increase the mechanical properties/strength of the frame 12 and of the thin film 14.

The thin film 14 may be established such that it covers (but does not substantially penetrate) the area of each of the plurality of apertures 20 that corresponds with the face 16, 18 of the frame 12 that the thin film 14 contacts.

FIGS. 4 and 4A depict still another embodiment of the electrolyte assembly 10. In this embodiment, the thin film 14 contacts a frame 12 having pores 32 throughout. As shown, the thin film 14 contacts the frame 12 at the first face 16 such that the film 14 is supported by the frame 12. It is to be understood, however, that the thin film 14 may alternatively contact the frame 12 at its second face 18 (as shown in FIGS. 2 and 3).

In this embodiment, the frame 12 may be any suitable substrate having pores 32 defined therein. Examples of suitable porous substrates include, but are not limited to porous polymers, porous inorganic membranes, porous metal sheets, and/or the like. Generally, the pores 32 have a size ranging from about 10 microns to about 100 microns. Examples of method(s) for forming such porous substrates are described in U.S. Pat. No. 6,656,526, entitled “Porously Coated Open-Structure Substrate and Method of Manufacture Thereof”, issued Dec. 2, 2003, to Alfred I-Tsung Pan, the disclosure of which is incorporated herein by reference in its entirety.

In an embodiment in which the frame 12 is a substrate having pores 32 defined therein, it is to be understood that the thin film 14 does not substantially penetrate the pores 32, rather the thin film 14 may cover and/or contact at least some of the pores 32 on the face 16, 18 of the frame 12 upon which it is established.

Referring now to FIG. 5, in an embodiment of the present disclosure, a fuel cell 100 includes at least one electrode 34, 36 in electrochemical contact with an electrolyte 10. It is to be understood that the electrode 34, 36 may be an anode 34 or a cathode 36. It is to be further understood that the electrolyte 10 may be an embodiment of the electrolyte assembly 10 as disclosed herein.

It is to be understood that the fuel cell 100 may be a Direct Methanol Polymer Electrolyte Membrane fuel cell.

In the fuel cell 100 embodiments, oxidants 38 are carried to the cathode 36, and reactants 40 are carried to the anode 34. In an embodiment, the reactants 40 are fuels, and the oxidants 38 are one of oxygen, air, and mixtures thereof. In an embodiment, the fuel/reactant 40 is methanol. Suitable fuels may be chosen for their suitability for internal direct reformation, suitable vapor pressure within the operating temperature range of interest, or like parameters.

An embodiment of a method of using fuel cell 100 includes the step of operatively connecting the fuel cell 100 to electrical load L and/or to electrical storage device S. The electrical load L may include many devices, including, but not limited to any or all of computers, portable electronic appliances (e.g. portable digital assistants (PDAs), portable power tools, etc.), and communication devices, portable or otherwise, both consumer and military. The electrical storage device S may include, as non-limitative examples, any or all of capacitors, batteries, and power conditioning devices. Some exemplary power conditioning devices include uninterruptible power supplies, DC/AC converters, DC voltage converters, voltage regulators, current limiters, etc.

It is also contemplated that the fuel cell 100 may, in some instances, be suitable for use in the transportation industry, e.g. to power automobiles, and in the utilities industry, e.g. within power plants.

A method of using an embodiment of the thin film electrolyte assembly 10 disclosed herein includes operatively disposing the thin film electrolyte assembly 10 in a fuel cell 100.

Embodiments of the electrolyte assembly 10 as disclosed herein offer many advantages, including, but not limited to the following. The electrolyte assembly 10 may advantageously substantially prevent fuel crossover in a fuel cell. This may be due in part to the presence of the metal layer 22. Further, the electrolyte assembly 10 having thin electrolyte membrane layers 30 may substantially prevent the cracking of the metal layer 22. Further, the electrolyte assembly 10 may be a thin film structure. Advantages of a thin film structure include, but are not limited to, a substantial reduction in fuel cell system impedance and a substantial increase in the efficiency of the fuel cell system's current delivery.

While several embodiments have been described in detail, it will be apparent to those skilled in the art that the disclosed embodiments may be modified. Therefore, the foregoing description is to be considered exemplary rather than limiting.

What is claimed is:

1. A thin film electrolyte assembly, comprising:
a frame; and
a thin film at least partially contacting the frame, the thin film comprising:
a metal layer having two opposed sides;
a large surface area metal layer established on each of the two opposed sides of the metal layer; and
an electrolyte membrane established on each of the large surface area metal layers.

2. The thin film electrolyte assembly as defined in claim 1 wherein the metal layer is selected from niobium, vanadium, tantalum, palladium, iron, alloys thereof, and combinations thereof.

3. The thin film electrolyte assembly as defined in claim 1 wherein the large surface area metal layers are formed from one of palladium-black, tantalum-black, iron-black, vanadium-black, palladium-black having its surface covered with a layer of at least one of palladium or a palladium alloy, tantalum-black having its surface covered with a layer of at least one of palladium or a palladium alloy, iron-black having its surface covered with a layer of at least one of palladium or a palladium alloy, vanadium-black having its surface covered with a layer of at least one of palladium or a palladium alloy, and combinations thereof.

4. The thin film electrolyte assembly as defined in claim 3 wherein the large surface area metal layers are palladium-black layers, and wherein at least one of the palladium-black layers includes a platinum-containing catalyst on a surface thereof.

5. The thin film electrolyte assembly as defined in claim 1 wherein the frame includes an aperture extending therethrough, and a first and a second face, and wherein the thin film contacts one of the first and second faces and covers the aperture.

6. The thin film electrolyte assembly as defined in claim 1 wherein the frame includes a plurality of apertures extending therethrough, and a first and a second face, and wherein the thin film contacts one of the first and second faces and covers the plurality of apertures.

7. The thin film electrolyte assembly as defined in claim 1 wherein the frame includes a characteristic selected from electrically insulating, impermeable to fuel, impermeable to oxygen, insoluble in fuel, insoluble in water, and combinations thereof.

8. The thin film electrolyte assembly as defined in claim 1 wherein the frame is selected from polyimide membranes, nylon, nickel, silver, and combinations thereof.

9. The thin film electrolyte assembly as defined in claim 1 wherein the frame is a substrate having a plurality of pores therein, and wherein the thin film contacts at least some of the plurality of pores.

10. The thin film electrolyte assembly as defined in claim 1 wherein each of the large surface area metal layers has a thickness ranging from about 10 nanometers to about 100 microns.

11. The thin film electrolyte assembly as defined in claim 1 wherein the metal layer has a thickness ranging from about 10 nanometers to about 100 microns.

12. The thin film electrolyte assembly as defined in claim 1 wherein each of the electrolyte membranes has a thickness ranging from about 1 micron to about 50 microns.

13. A method of making a thin film electrolyte assembly, the method comprising:
forming a thin film, the thin film including:
a metal layer having two opposed sides;
a large surface area metal layer established on each of the two opposed sides of the metal layer; and
an electrolyte membrane established on each of the large surface area metal layers; and
attaching the thin film to at least a portion of a frame.

14. The method as defined in 13 wherein each of the large surface area metal layers is established by electroplating, sputtering, evaporation, or combinations thereof.

15. The method as defined in claim 13 wherein the electrolyte membrane is established by casting, lamination, or combinations thereof.

16. The method as defined in claim 13 wherein the frame includes a first and a second face, and wherein the thin film is attached to one of the first and second faces of the frame.

17. A fuel cell, comprising:
at least one electrode operatively disposed in the fuel cell; and
an electrolyte assembly in electrochemical contact with the at least one electrode, the electrolyte assembly including:
a frame; and
a thin film at least partially contacting the frame, the thin film comprising:
a metal layer having two opposed sides;
a large surface area metal layer established on each of the two opposed sides of the metal layer; and
an electrolyte membrane established on each of the large surface area metal layers.

18. The fuel cell as defined in claim 17 wherein the metal layer is selected from niobium, vanadium, tantalum, palladium, iron, alloys thereof, and combinations thereof, and wherein the large surface area metal layers are palladium-black layers.

19. The fuel cell as defined in claim 17 wherein the fuel cell is a direct methanol fuel cell.

20. An electronic device, comprising:
a load; and
the fuel cell of claim 17 connected to the load.
